(19) United States
(12) Patent Application Publication
(10) Pub. No.: US 2002/0158729 A1
(43) Pub. Date: Oct. 31, 2002

(54) Electromagnetic contactor and method for eliminating errors in assembling the same

(76) Inventors: Sudarshan Allada, Andhra Pradesh (IN); Padmanabham Thatigolla, Andhra Pradesh (IN); Gowda Maharudrappa Vishwanatha, Karnataka (IN); Nicholas John DiCarlo, West Hartford, CT (US); Thomas Randolph Campbell, Washington, CT (US); Robert John Casagrandle, Oxford, CT (US); Hamon Leroy Craft, Plainville, CT (US)

Correspondence Address: PATENT OPERATION, GENERAL ELECTRIC COMPANY, 41 WOODFORD AVENUE, PLAINVILLE, CT, 06062

(21) Appl. No.: 10/120,282

(22) Filed: Apr. 10, 2002

Related U.S. Application Data
(62) Division of application No. 09/681,542, filed on Apr. 25, 2001, now abandoned.

(51) Int. Cl. H01H 67/02

(52) U.S. Cl. 335/132

(57) ABSTRACT

An electromagnetic contactor that is designed for error-free assembly. The housing includes a contactor carrier interference that fixes the orientation between the housing and contact carrier. Orientation between the contact carrier and the armature is fixed by an offset elliptical joint. Pole shader interferences fix the orientation between the coil cover subassembly, the armature and the magnet. Shoulders located on two of four base legs fix the orientation between the housing and the base. The base includes a rail spring, spring catches, upper and lower catches that allow the contactor to be mounted on a DIN rail without using tools.

This is a divisional of application Ser. No. 09/681,542, filed Apr. 25, 2001.

### TECHNICAL FIELD

The invention relates generally to electromagnetic contactors and, in particular, to contactors assembled without fasteners. The invention further relates to a contactor design and corresponding method that eliminate errors in contactor assembly. Additionally, the invention relates to a contactor designed for rail mounting.

### BACKGROUND OF THE INVENTION

Electromagnetic contactors are employed in electrical systems to open and close electrical circuits that supply power to equipment such as motors, lighting circuits, resistance heaters and other electrical loads. Contactors are designed for frequent operation and supplied in a wide range of voltage and current ratings to meet the system requirements. Contactor components include a coil, armature, stationary magnet and electrical contacts. Generally, the electrical contacts are wired in series with an electrical load. The contactor coil is connected to a power source via a manual or automatic control component such as a pushbutton switch, relay, distributed control system, programmable logic controller, or the like. The contacts close when the contactor coil is energized and the armature is drawn towards the stationary magnet. The electrical load begins to receive power when the contacts are closed. Conversely, the contacts open and disconnect power from the electrical load when the contactor coil is de-energized.

State of the art contactors use a stationary magnet and a moveable magnet also referred to as an armature. The contactor armature and magnet are manufactured from ferromagnetic material that is laminated to reduce eddy currents. Generally, both the armature and magnet include a shading coil, also referred to as a pole shader, to maintain an attractive force between the magnet and armature when the periodic AC waveform reaches a momentary current zero. Effective pole shading reduces contactor vibration resulting in much quieter contactor operation. However, pole shaders are ineffective when the pole shaders of the magnet and armature are adjacent one another.

Generally the magnet and armature are shaped differently from one another. However, the unique shapes increases the number of unique parts required to manufacture the contactor. The increased parts add cost and complexity to contactor design and manufacture because additional drawings and a unique part design are required. Additionally, the cost of maintaining a unique part adds significant costs to manufacturing and product support over the life of the product.

The magnet and the armature can have an identical design. However, identical parts are easily installed in the wrong orientation without the error being detected. The incorrect orientation leaves the pole shaders adjacent one another.

Contactor design has evolved to take advantage of modem manufacturing techniques. Specifically, manufacturer's have developed fastenerless contactor designs to allow automated manufacture. However, state of the art contactors do not include features that assure that proper component orientation during the assembly process. For example, state of the art contactor designs do not prevent contactor assembly with the magnet pole shaders adjacent one another. Nor do state of the art contactor designs assure complete assembly without errors.

Thus, existing contactor designs are prone to manufacturing errors because they can be assembled with missing or improperly oriented parts. These errors can lead to a contactor that performs poorly or not at all. Assembly errors are especially costly and inefficient in automated assembly processes because they are often not detected until after final assembly when the device is tested.

Generally, state of the art contactors are designed for panel mounting using screws. Rail mounting is becoming an increasingly common means of securing electrical control devices such as contactors, circuit breakers and the like within enclosures and cabinets. The mounting rail is first secured within the cabinet or enclosure. The contactor is then secured to the mounting rail. DIN rail is a common type of mounting rail. DIN rail is hat shaped and is comprised of a flat base having parallel upwardly extending flanges that each include a narrow outward turned lip.

State of the art contactors do not include rail mounting hardware as an integral component of the contactor structure. Manufacturer's have developed separate mounting bases that are designed to attach a contactor to a mounting rail. These designs have traditionally used plastic components to provide flexibility and allow the device to grasp the DIN rail flanges. However, metal mounting bases are typically used for mounting contactors directly to a panel. Thus, plastic contactor bases are not preferred for the dual purposes of panel and rail mounting. Some manufacturer's have designed separate metal bases that attach to both a DIN rail and a control component. These provide the advantages of metal construction but have the higher cost and complexity associated with separate components.

### SUMMARY OF THE INVENTION

It is therefore advantageous to design an electromagnetic contactor where the various components assist in preventing improper contactor assembly, and a method of assembling the same. It is also desirable to manufacture an electromagnetic contactor with improved installation and mounting features including integral rail mounting hardware. Further advantages are gained where an electromagnetic contactor includes integral features that allow both rail and panel mounting. Additional advantages are gained when the above features are included in a contactor that has a low total part count and a minimum number of unique parts.

Accordingly the present invention provides an electromagnetic contactor containing interferences that prevent contactor misassembly. The present invention includes integral rail mounting hardware and panel mounting features providing the invention with yet additional advantages. Also provided is a method of error-free assembly of an electromagnetic contactor.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of instrumentalities and combinations particularly pointed out in the appended claims.

### BRIEF DESCRIPTION OF THE DRAWINGS

FIG. 1 is an exploded isometric view of an electromagnetic contactor according to the invention;

FIG. 2 is an interior view of the housing of FIG. 1;

FIG. 3 is an exploded isometric view of the contact carrier of FIG. 1;

FIG. 4 is an exploded isometric view of the contact carrier subassembly of FIG. 1;

FIG. 5 is an isometric view of the contact carrier subassembly of FIG. 1 viewed from the side that is first inserted in the housing;

FIG. 6 is an isometric view of the contactor of FIG. 1 attached to a mounting rail viewed from the underside of the mounting rail;

FIG. 7 is an isometric view of the contactor of FIG. 1 attached to a mounting rail viewed from the topside of the mounting rail;

FIG. 8 is an isometric bottom view of the base of FIG. 1;

FIG. 9 is an isometric top view of the base of FIG. 1; and

FIG. 10 is an isometric view of the coil cover assembly of FIG. 1.

### DESCRIPTION OF THE PREFERRED EMBODIMENTS OF THE INVENTION

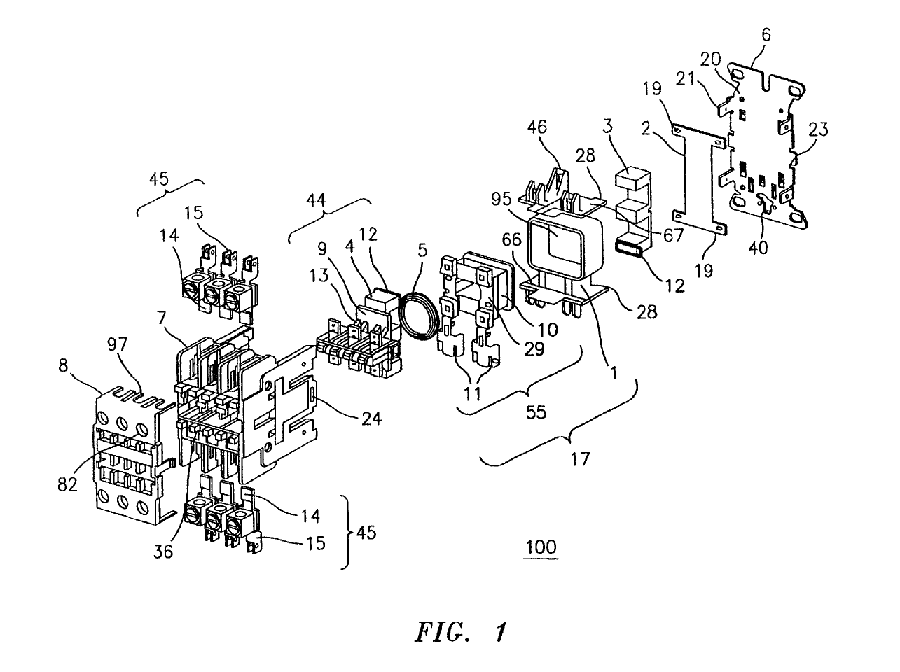

FIG. 1 shows an exploded isometric view of an electromagnetic contactor 100 according to the present invention. The contactor 100 is assembled without fasteners by stacking, snapping and slideably engaging components and subassemblies together to secure the components and subassemblies in place. Most individual components and subassemblies include features that prevent the components or subassemblies from being installed incorrectly. FIG. 1 shows that components secured between the housing 7 and base 6 include a contact carrier subassembly 44, a return spring 5, a coil cover subassembly 17, a magnet 3, and a vibration damper 2. Stationary contact subassemblies 45 and a housing cover 8 are inserted into the housing 7 from the exterior of the housing 7. The stationary contact subassemblies 45 include stationary contacts 14 and field wiring terminals 15. The contact pairs formed by moveable contacts 13 and stationary contacts 14 are open when the contactor 100 is de-energized because the return spring 5 forces the contact carrier assembly into the housing 7 in a direction away from the coil cover subassembly 17 and magnet 3. The contactor 100 operates when the coil 10 receives AC power via coil terminals 11 and the resulting electromagnetic force draws the armature 4 towards the magnet 3. The force overcomes the resistance of the return spring 5 and the entire contact carrier subassembly 44 travels toward the coil cover subassembly 17. The moveable contacts 13 engage the stationary contacts 14 and remain engaged so long as the coil 11 remains energized. When power is removed from terminals 11 the return spring 5 forces the contact carrier subassembly 44 into the housing 7 in a direction away from the coil cover subassembly 17, opening contacts 13, 14.

FIG. 1 also shows the overload relay latch 46 that in a preferred embodiment is an integral part of the coil cover 1. The overload relay latch 46 is used to attach an external overload relay (not shown) that is used to provide overload protection in some contactor applications.

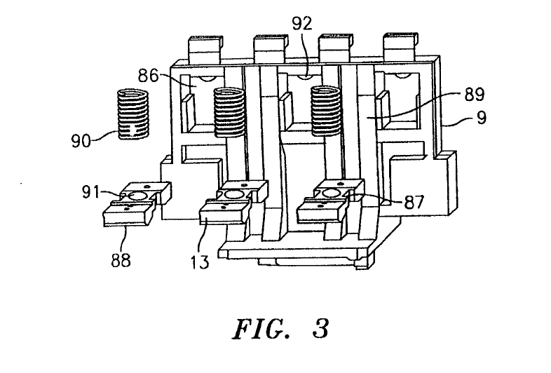

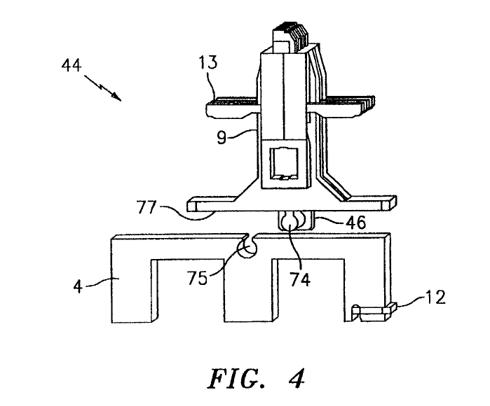

FIG. 3 and FIG. 4 show the assembly of the contact carrier subassembly 44. In FIG. 3 moveable contacts 13 are inserted in offset slots 86 in the contact carrier 9. Each contact is double ended having a contact surface 88 located at each end of the moveable contact 13. The width of the movable contact central section 87 of the contacts 13 engage the offset slots 86 to prevent the contacts 13 from being installed upside down. Individual contact springs 90 having a helical shape are compressed between the contact carrier 9 and moveable contact central section 87 to hold each contact 13 in place and provide contact pressure when the moveable 13 and stationary contacts 14 are engaged. Two opposing spring nubs 91, 92 capture the ends of the hollow spring body 89 to insure positive assembly and prevent the spring 90 from becoming dislodged. A first nub 91 is located on the moveable contact central section 87 and a second nub 92 is located on the contact carrier 9. It will be recognized that the spring nubs 91, 92, the offset slots 86 and the moveable contact central section 87 can be provided by a variety of alternate cooperating geometric structure such as abutments and the like.

FIG. 4 shows the ellipse 74 with a stop 76 that are located on the otherwise planar surface 77 of the contact carrier 9. The ellipse 74 engages a ellipse slot 75 located in the armature 4. The contact carrier subassembly 44 is complete when armature 4 is attached to the contact carrier 9 by sliding the ellipse 74 into the ellipse slot 75 until the stop 76 abuts the side of the armature 4. The stop 76 allows the armature 4 to be secured to the contact carrier 9 in only a single direction because it interferes with the armature 4 in other orientations. Additionally, both the ellipse 74 and the ellipse slot 75 have matching offsets. The offsets prevent the ellipse 74 from cooperatively engaging the ellipse slot 75 unless the armature is attached in the correct orientation. Thus, the contact carrier subassembly 44 cannot be assembled unless the armature 4 is installed correctly.

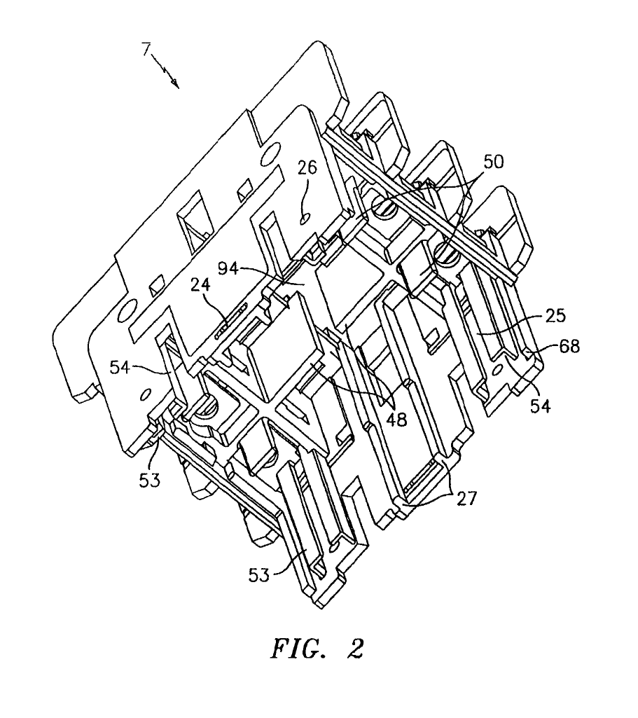

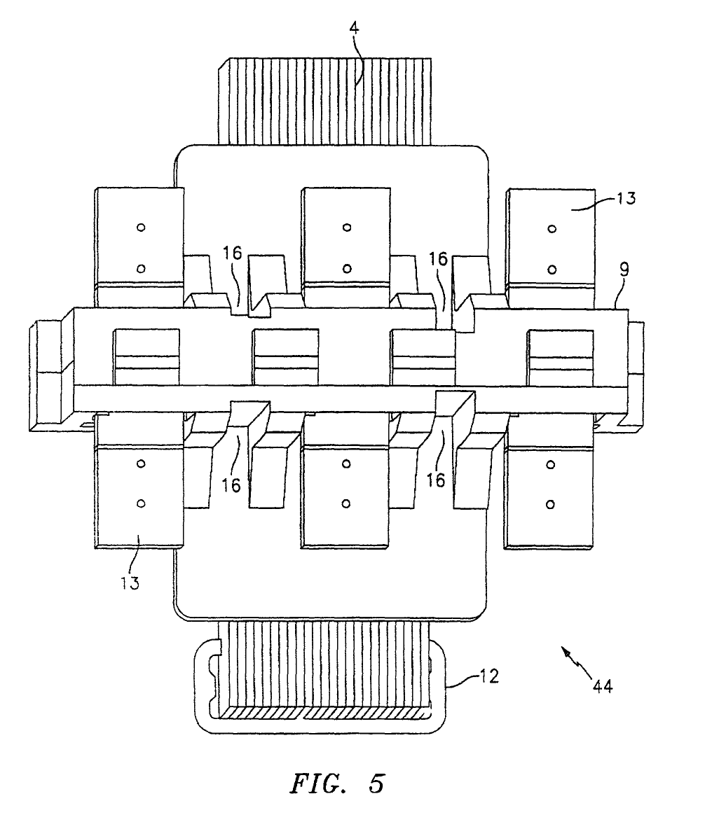

To assemble the contactor 100, the completed contact carrier subassembly 44 is inserted into the housing 7. The contact carrier 9 includes at least one carrier channel 16, shown in FIG. 5, which cooperatively engages at least one contact carrier interference 48, shown in FIG. 2, when the contact carrier subassembly 44 is properly oriented relative the housing 7. The contact carrier interference 48 prevents the contact carrier subassembly 44 from cooperatively engaging the housing when the carrier subassembly 44 is oriented improperly. In a preferred embodiment of FIG.2 the at least one contact carrier interference 48 is shown in the form of inner fins, two of the four inner fins are obscured in FIG. 2. The preferred embodiment also shows the at least one carrier channel 16 in the form of grooves in the contact carrier 9, FIG. 5. The fixed orientation is assured because the carrier interference 48 creates an interference gap 94. Each interference gap 94 has a unique width that corresponds to the thickness of the contact carrier 9 between a single pair of opposing carrier channels. It will be recognized that the contact carrier interference 48 and carrier channel 16 can be provided by a variety of alternate cooperating projections and geometric shapes such as abutments and the like.

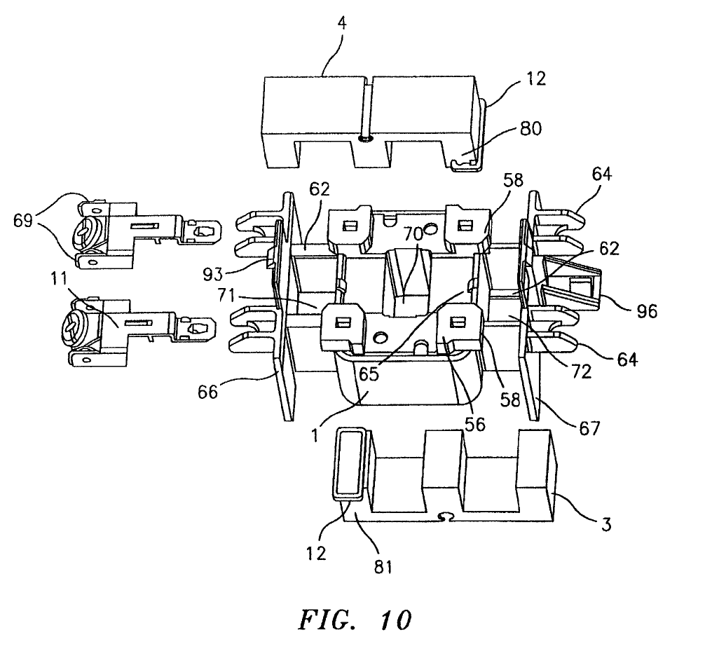

A particular advantage of the invention is that the fixed orientation of the contact carrier subassembly 44 results in a fixed orientation of the armature 4 relative to the housing 7. FIG. 10 shows a pole shader 12 located at the magnet shading end of armature 4. The orientation of the pole shader 12 is fixed relative to the contact carrier 9 by the offset ellipse connection between the armature 4 and contact carrier 9. Thus, the orientation of the pole shader 12 is fixed relative to the housing 7.

FIG. 1 shows the coil 10 formed by wrapping turns of wire around a coil bobbin 29. The coil bobbin 29, FIG. 10, includes a substantially rectangular inner surface 65 having terminal abutments 56 located at each of four corners. The terminal abutments 56 include terminal slots 58 that allow coil terminals 11 to be inserted into the abutments 56. The coil terminals 11 can be secured to the coil leads (not shown) by a variety of means including soldering, compression connections and the like. The coil leads are wrapped around the terminals 11 then soldered in place in a preferred embodiment. The terminals 11 can be used with either screw terminations or quick connection to either or both terminal blades 69. A coil subassembly 55 is complete when the terminals 11 are fully installed. The coil subassembly 55 is then installed in the coil cavity 95 located within coil cover 1 to form a complete coil cover subassembly 17. FIG. 1 shows a coil cover subassembly 17 that is comprised of a coil cover 1 and a coil subassembly 55. The coil subassembly 55 has the terminals removed in this particular view. A first magnet cavity 71 and a second magnet cavity 72 are located on either side of the coil cavity 95. The terminal abutments 56 and slots 58 are oriented to allow the coil terminals 11 to be supported by terminal supports 64 attached to a first end wall 66 and a second end wall 67.

As shown in FIG. 1, the coil cavity 95 is not large enough to allow the coil subassembly 55 to be installed incorrectly in the coil cover 1 because the width of the bobbin 29 at the terminal abutments 56 is greater than the width of the coil cavity 95. Additionally, the coil subassembly 55 cannot be installed from the wrong end of the coil cavity 95 because the coil cover 1 interferes with the coil terminals 11. The bobbin 29 also includes a central magnet cavity 70. The center pole of the magnet 3 and armature 4 fit within the central magnet cavity 70 when the contactor 100 is fully assembled. The bobbin 29 design provides further advantages because the shape and location of the terminal abutments 56 provide a snug fit for the fixed end of return spring 5 when the return spring 5 is set on the substantially rectangular inner face 65. The return spring 5 has a helical shape and a conical taper from the broad fixed end to a narrow moveable end that captures the center pole of the armature 4. The shape of the return spring 5 also prevents incorrect installation of the spring 5 because the narrow end of the spring 5 cannot be fitted securely on inner face 65 between terminal abutments 56. The conical shape of return spring 5 provides a constant spring force as the spring is compressed.

The coil cover subassembly 17 is inserted into the housing 7 where the central cavity 70, first magnet cavity 71 and second magnet cavity 72 align with the three poles of the armature 4. A return spring 5 is inserted between the coil cover subassembly 17 and contact carrier subassembly 44 prior to inserting the coil cover subassembly 17 into the housing 7. FIG. 2 shows corner ribs 68 that are located at each corner of the housing 7. The corner ribs 68 align the coil cover subassembly 17 as it is inserted into the housing 7. End wall tabs 93 provide a snap fit of the coil cover subassembly 17 to the housing 7.

The coil cover subassembly 17 orientation is fixed relative to the contact carrier subassembly 44 by at least one pole shader interference 62. In one preferred embodiment shown in FIG. 10 the pole shader interferences 62, are shown in the form of lips. However, persons skilled in the art will recognize that the pole shader interference 62 can be provided in a variety of structures such as tabs and the like. FIG. 10 shows the at least one pole shader interference 62 located on the inner end of the first magnet cavity 71 and the on the outer end of the second magnet cavity 72. A portion of pole shader interference associated with second magnet cavity 72 is obscured in the drawing.

A particular advantage of the invention, shown in FIG. 10, is that pole shader interferences 62 prevent the contactor 100 from being assembled with the armature shading pole 80 and the magnet shading pole 81 adjacent one another. The magnet 3 is slid into the outer end of the coil cover subassembly 17, FIG. 1. The pole shader interference 62 prevents the magnet shading pole 81 from being installed in the second magnet cavity 72. Thus, the magnet 3 orientation is fixed relative to the coil cover subassembly 17 when the contactor 100 is assembled. The magnet 3 is also installed in a fixed orientation relative to the housing 7 as a result of the fixed orientation of the coil cover subassembly 17.

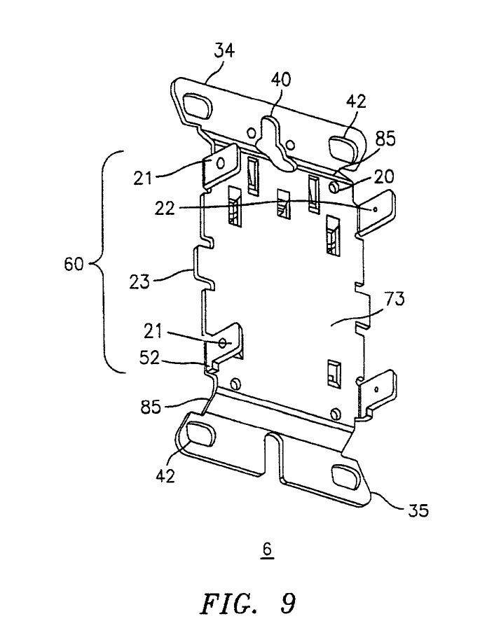

Referring back to FIG. 1, contactor 100 assembly is completed when a vibration damper 2 is placed between the magnet 3 and base 6, and the base is snapped onto the housing. The vibration damper 2 is made from a flexibly resilient material. The damper 2 is in the form of a rubber mat in the preferred embodiment. However, it will be recognized that damper 2 can be provided in a variety of designs such as springs and the like. The vibration damper 2 eliminates the transmission of vibration from the magnet 3 to the base 6. Additionally, the vibration damper 2 takes up any slack that may exist in the contactor due to manufacturing tolerances. The base 6 includes base assembly structure 60. The assembly structure 60 is received by the housing 7 and provides a means for securing the base 6 to the housing 7. The base 6 may be manufactured of metal, plastic or other suitable material. However, metal, in particular steel, is preferred because of its strength and durability. In one preferred embodiment shown in FIG. 9 the base assembly structure 60 is in the form of four base legs 21 and two base mounting tabs 23 . The tabs 23 are located at the center of the long outer edge of the base 6. The base legs 21 are located at the outer edge of the base 6 close to the point where the flanges 34, 35 meet the base central plate 73. Persons skilled in the art will recognize that the base assembly structure 60 can be incorporated by adjusting the shape, quantity and location of the base assembly structure.

Each base leg 21 includes leg protrusions 22. Two legs also include shoulders 52. The corresponding engagement features included in the housing 7 are best seen in FIG. 2. Each leg is inserted into leg slots 25 that are defined by L-shaped ribs 54. Two leg slots 25, include short L-shaped ribs 53. The two base legs 21 that include shoulders 52 cannot be installed in a leg slot 25 unless the leg slot 25 is equipped with a short L-shaped rib 53. Standard length L-shaped ribs 54 interfere with the shoulders 52. Thus, the assembly structure and corresponding housing components allow contactor assembly only when the housing 7 and base 6 are in a single pre-determined orientation relative to one another. Leg protrusions 22 are included on each leg to insure proper component alignment and provide a positive snap-fit between the base 6 and the housing 7. The leg slots 25 and associated housing 7 deflect outward when the leg protrusions 22 enter the slots 25. The protrusions 22 then snap into the leg alignment holes 26 when the housing 7 and base 6 are properly aligned.

The base mounting tabs 23 and the tab slits 24 provide further positive contactor assembly and component alignment. The tab slit 24 is formed in the sidewall of housing 7 along the center of the edge that meets the long outer edge of the base 6. The base 6 has a rigid construction and the snap-fit of the base mounting tabs 23 to the tab slits 24 is accomplished as the base mounting tabs 23 deflect the housing 7 outward when the base 6 and the housing 7 are slid together. The mounting tab ribs 27 extend parallel to one another from the tab slits 24 into the interior of the housing 7. The mounting tab ribs 27 engage the contact carrier 9 and act to guide the contact carrier subassembly 44 into a central alignment within the housing 7.

FIG. 1 shows coil cover mounting tabs 28, located at the base of the first end wall 66 and second end wall 67. A total of four coil cover mounting tabs 28 are included in the preferred embodiment, two on each end wall 66, 67 (two of the four tabs are obscured in the drawing). The coil cover mounting tabs 28 protrude through the damper alignment holes 19 in the damper 2 when the damper is properly aligned with the coil cover subassembly 17. The damper 2 is then secured in a fixed location when the tabs 28 engage the corresponding base alignment holes 20 located at the four corners of the central plate 73.

It will be recognized that the assembly steps are independent of order. Additionally, subassemblies can be used to a greater or lesser degree to pre-assemble component groups as desired.

FIG. 9 shows an isometric view of the base 6 as viewed from the contactor side of the base 6. The base 6 includes the assembly structure 60 located in the central plate 73 which is substantially planar in shape. An upper flange 34 and a lower flange 35 are located at opposite ends of the central plate 73. The flanges 34, 35 lie in a plane parallel to the central plate 73 but are offset from the central plate 73 because each flange 34, 35 is joined to the central plate 73 by a sloped section 85. Two mounting holes 42 are located in each flange 34, 35. The mounting holes 42 allow the base 6 to be flush mounted to a panel using fasteners typically in the form of screws, bolts, or similar such fasteners. Additionally, a keyhole 40 is provided in the upper flange 34. The keyhole 40 provides another means of panel mounting and helps orient the contactor 100. Generally the keyhole 40 is located above the contactor housing 7 when the contactor is mounted on a vertical panel. A known orientation allows the contactor 100 to be assembled with coil terminals 11 accessible from above.

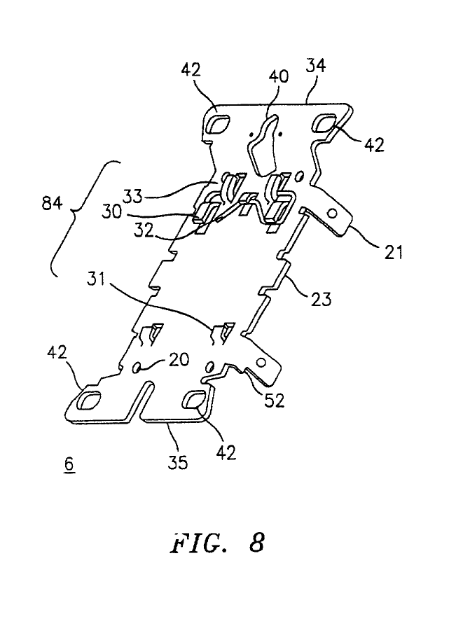

The base 6 includes additional advantages shown in FIG. 8. The offset construction of the flanges 34, 35 relative to the central plate 73 allow for integral rail mounting hardware 84 on the outer side of the base 6. FIG. 8 shows a preferred embodiment having rail mounting hardware 84 designed for use with a DIN rail. It will be recognized by persons skilled in the art that the invention is not limited to use with DIN rails, but can be modified for use with other rail mounting systems. Rail mounting hardware 84 includes at least one spring catch 33 that secures a rail spring 32 to the base 6. In the preferred embodiment the rail spring 32 is a wire spring formed in substantially the shape of a W with the ends turned inwards. The preferred embodiment also includes two spring catches 33 that capture opposing ends of the rail spring 32 while a third spring catch 33 captures the center of the rail spring 32. However, it will recognize that the invention includes rail springs 32 manufactured in other configurations such as U, S, N, L shapes and the like so long as the spring can be secured to the underside of base 6 and provide biasing force to securely engage the base 6 to the DIN rail. Additionally, it will also be recognized that the quantity and location of the at least one spring catch 33 can be adjusted to suit a variety of rail springs 32.

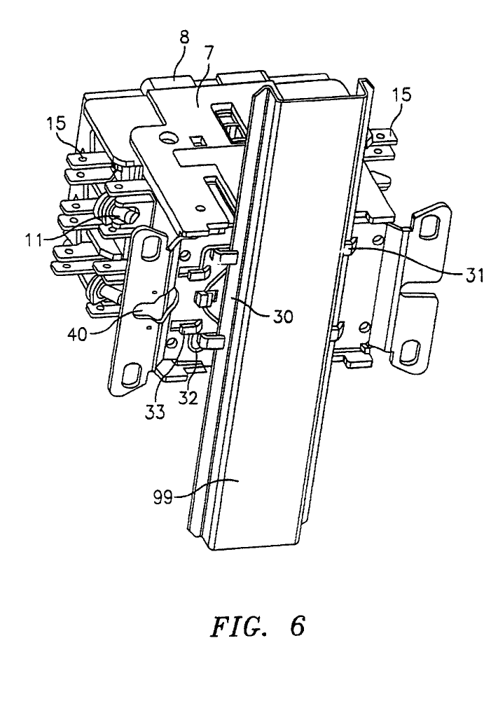

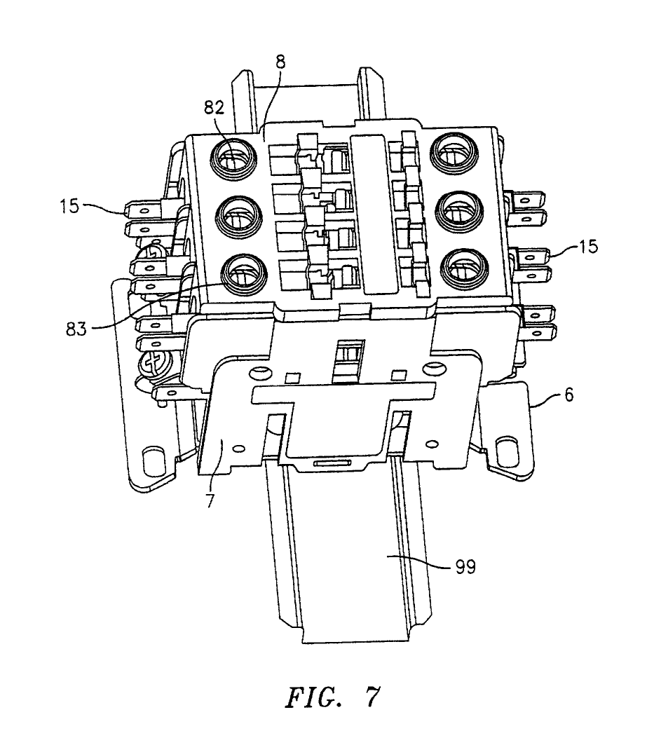

The invention includes at least one upper rail catch 30 and at least one lower rail catch 31 that secure the contactor 100 to the mounting rail. In a preferred embodiment shown in FIG. 8 the upper rail catch 30 is comprised of two catches open toward the center of the base 6. The rail spring 32 travels between the two upper catches 30 and the base 6. In FIG. 6 and FIG. 7 the preferred embodiment of the invention is used with a DIN rail 99. The contactor 100 is installed on the rail 99 by hooking the upper catch 30 over one of the flanges of rail 99 and pulling the contactor 100 toward the opposite flange so that the rail spring 32 is compressed within the upper catch 30. The contactor 100 is then pivoted toward the rail 99 and released when the lower catch 31 is extended beyond the opposite flange so that the lower catch 31 engages the opposite flange. The rail spring 32 provides a biasing force that provides the contactor base 6 a secure fit with the rail when the contactor 100 is released. A particular advantage of the structure of FIG. 8 is that it allows for contactor rail mounting without using tools. Additionally, the rail mounting hardware 84 provides positive and secure engagement with the rail 99 using only a single moving part. Thus, it is very reliable, easy to use and less expensive to manufacture than alternate designs. Finally, persons of skill in the art will recognize that the invention can be applied universally to other equipment mounted on rails such as circuit breakers, relays and the like.

The structure of housing cover 8 provides the additional advantages of preventing unintentional contact with the stationary contact subassembly 45 of the fully assembled contactor 100. The added safety is provided by incorporating degrees of protection provided by enclosures as described for IEC rated equipment. For example, IEC Code 20. FIG. 1 shows the top access ports 82 that allow access to the contact subassembly 45. The access port 82 allows a screwdriver tip to be inserted beneath the housing cover 8 to engage the stationary terminal screw 37. Each port 82 includes an access port extension 83, shown in FIG. 7, that extends away from the cover 8. Additionally, the cover 8 includes sidewall extensions 97, shown in FIG. 1, that are shaped substantially like an upside down U. The housing cover 8 is secured to the housing 7 by cover legs 98. The cover legs 98 slide inside the housing 8 to provide a snap fit of the housing cover 98 to the housing 7. The housing 7 and housing cover 8 can only be installed in a single fixed orientation because the housing 7 includes a plurality of offset projections 36. The offset projections 36 interfere with the housing cover 8 if the cover 8 is incorrectly aligned with housing 7. The projections 36 are comprised of T and L shaped structure that allows for the attachment of external devices such as auxiliary switches and the like.

In a preferred embodiment shown in FIG. 1 the housing 7 is manufactured from thermoplastic. Thermoplastic provides a structure that is substantially rigid but has the flexibility required for the snap together assembly features. However, other materials with similar combinations of rigidity and flexibility would be equally acceptable. The cover 8, bobbin 29 and coil cover 1 are also manufactured from thermoplastic in another preferred embodiment. Additionally, the thermoplastic used for the coil cover 1 and bobbin 29 is UL approved for use in an insulation system.

What is claimed is:

1. An electromagnetic contactor, comprising:
a housing;
a contact carrier subassembly including moveable contacts;
a stationary contact subassembly;
a coil cover subassembly;
a magnet;
a base; and
at least one pole shader interference that allows assembly of said contact carrier subassembly and a lower magnet only where an armature pole shader is not adjacent to a magnet pole shader.

2. The electromagnetic contactor as claimed in claim 1, wherein said pole shader interference is an integral part of said coil cover.

3. The electromagnetic contactor as claimed in claim 2, wherein said pole shader interference forms a lip.

4. The electromagnetic contactor as claimed in claim 1, wherein said pole shader interference limits coil cover insertion in said housing to a single, fixed orientation.

5. The electromagnetic contactor as claimed in claim 1, wherein said moveable contact carrier includes at least one carrier channel.

6. The electromagnetic contactor as claimed in claim 5, wherein said housing includes at least one carrier interference that cooperatively engages said carrier channel and allows insertion of said contact carrier subassembly in said housing in a single, fixed orientation.

7. The electromagnetic contactor as claimed in claim 1, wherein a contact carrier is attached to said armature by an offset joint.

8. The electromagnetic contactor as claimed in claim 1, wherein said housing includes offset projections that allow the installation of a housing cover on said housing in a single, fixed orientation.

9. The electromagnetic contactor as claimed in claim 8, wherein said offset projections have a projection shape that provides a secure connection for an external auxiliary switch.

10. The electromagnetic contactor as claimed in claim 9, wherein said housing cover includes cover legs that snap fit to said housing.

11. The electromagnetic contactor as claimed in claim 10, wherein said housing cover includes access port extensions and sidewall extensions that protect against accidental contact with said stationary contact subassembly.

12. The electromagnetic contactor as claimed in claim 1, wherein a vibration damper is located beneath said lower magnet.

13. The electromagnetic contactor as claimed in claim 12, wherein said coil cover subassembly and said vibration damper are in a fixed orientation relative to one another.

14. The electromagnetic contactor as claimed in claim 13, wherein said vibration damper includes at least one damper alignment hole.

15. The electromagnetic contactor as claimed in claim 14, wherein said base includes at least one base alignment hole.

16. The electromagnetic contactor as claimed in claim 1, wherein said base includes at least one base mounting tab.

17. The electromagnetic contactor as claimed in claim 16, wherein said housing includes at least one mounting tab slit that engages said base mounting tab to attach said base to said housing when contactor is assembled.

18. The electromagnetic contactor as claimed in claim 17, wherein said base includes at least one catch to allow said contactor to be mounted on a DIN rail.

19. A method of error free assembly of an electromagnetic contactor, comprising the steps of:
providing a contactor housing with at least one carrier interfence;
inserting a contact carrier subassembly having at least one carrier channel into said housing, wherein said carrier interference and said carrier channel cooperatively engage only when said contact carrier subassembly and said housing are in a single fixed orientation;
inserting a coil cover subassembly, wherein insertion is only allowed where said coil cover subassembly and said contact carrier subassembly are in a single fixed orientation;
inserting a magnet in said coil cover assembly;
securing a base to said housing, wherein the contact carrier subassembly, and coil cover subassembly are secured between said housing and said base; and
inserting stationary contact subassemblies into said housing.

20. The method of claim 19, wherein said base attaches to said housing in a single fixed orientation, wherein the contact carrier subassembly, the coil cover subassembly, and the magnet, are secured in proper orientation when said base and housing are attached.

21. The method of claim 20, wherein said housing includes a removable top cover.

22. The method of claim 21, wherein a vibration damper is located between said base and said magnet.

23. The method of claim 22, wherein said vibration damper is a rubber mat.

24. An electromechanical contactor base, comprising:
assembly structure, wherein said assembly structure is secured to a contactor housing when an electromagnetic contactor is assembled;
at least one panel mounting hole; and
rail mounting hardware located on the underside of said base, wherein a user can directly secure said electromagnetic contactor to a planar surface or a mounting rail.

25. The electromechanical contactor base as claimed in claim 24, wherein said rail mounting hardware has a single moveable part.

26. The electromechanical contactor base as claimed in claim 25, wherein said single moveable part is a spring.

27. The electromechanical contactor base as claimed in claim 26, wherein said spring is a wire spring.

28. The electromechanical contactor base as claimed in claim 27, wherein said spring has a spring shape that allows said spring to engage at least one spring catch.

29. The electromechanical contactor base as claimed in claim 28, wherein said spring shape is substantially in the form of a W.

30. The electromechanical contactor base as claimed in claim 24, wherein said mounting rail is a DIN rail.

31. The electromechanical contactor base as claimed in claim 24, wherein said base can be attached and removed from said mounting rail without using a tool.

32. The electromechanical contactor base as claimed in claim 31, wherein said rail mounting hardware includes a spring.

33. The electromechanical contactor base as claimed in claim 31, wherein said rail mounting hardware includes at least one spring catch to secure said spring to said base.

34. The electromechanical contactor base as claimed in claim 32, wherein said spring is a wire spring.

35. The electromechanical contactor base as claimed in claim 34, wherein said rail mounting includes at least one upper rail catch and at least one lower rail catch to secure said base to said mounting rail.

36. The electromechanical contactor base as claimed in claim 35, wherein said spring travels within said upper rail catch when said spring is compressed during installation and removal of said base from said mounting rail.

37. The electromechanical contactor base as claimed in claim 36, wherein said assembly structure includes at least two base legs and at least one mounting tab.

38. The electromechanical contactor base as claimed in claim 24, wherein said base is metal

39. The electromagnetic contactor base as claimed in claim 24, wherein said base can be attached and removed from said mounting rail without using a tool.

40. The electromagnetic contactor base as claimed in claim 39, wherein said base is metal.

41. The electromagnetic contactor base as claimed in claim 40, wherein said rail mounting hardware has a single moveable part.

42. The electromagnetic contactor base as claimed in claim 41, wherein said single moveable part is a spring.

43. The electromagnetic contactor base as claimed in claim 42 wherein said mounting rail is a DIN rail.

44. An electromagnetic contactor designed for rail mounting comprising:
a housing;
a contact carrier subassembly including moveable contacts;
a stationary contact subassembly;
a coil cover subassembly;
a magnet;
a base that attaches to said housing, wherein the contact carrier subassembly, coil cover subassembly, and magnet are secured within said housing when said base and housing are attached, said base having at least one panel mounting hole and rail mounting hardware located on underside of said base, to allow a user to directly secure said electromagnetic contactor to a planar surface or a mounting rail.

45. The electromagnetic contactor as claimed in claim 44, wherein said mounting rail is a DIN rail.

46. The electromagnetic contactor as claimed in claim 45, wherein said base can be attached and removed from said mounting rail without using a tool.

47. The electromagnetic contactor as claimed in claim 46, wherein said rail mounting hardware includes a single moveable part.

48. The electromagnetic contactor as claimed in claim 47, wherein said single moveable part is a spring.

49. The electromagnetic contactor as claimed in claim 48, wherein said rail mounting hardware includes at least one spring catch to secure said spring to said base.

50. The electromagnetic contactor as claimed in claim 49, wherein said spring is a wire spring.

51. The electromagnetic contactor as claimed in claim 50, wherein said rail mounting includes at least one upper rail catch and at least one lower rail catch to secure said base to said mounting rail.

52. The electromagnetic contactor as claimed in claim 51, wherein said spring travels within said upper rail catch when said spring is compressed during installation and removal of said base from said mounting rail.

53. The electromagnetic contactor as claimed in claim 52, wherein said assembly structure includes at least two base legs and at least one mounting tab.

54. The electromechanical contactor as claimed claim 53, wherein said base is metal.
